(19) United States
(12) Patent Application Publication
(10) Pub. No.: US 2015/0204579 A1
(43) Pub. Date: Jul. 23, 2015

(54) HEAT EXCHANGER FOR USE IN A CONDENSING GAS-FIRED HVAC APPLIANCE

(71) Applicant: Carrier Corporation, Farmington, CT (US)

(72) Inventors: Michael L. Brown, Greenwood, IN (US); Michael F. Taras, Fayetteville, NY (US); Brian D. Videto, Cortland, NY (US)

(73) Assignee: Carrier Corporation

(21) Appl. No.: 14/558,162

(22) Filed: Dec. 2, 2014

Related U.S. Application Data
(60) Provisional application No. 61/929,653, filed on Jan. 21, 2014.

(51) Int. Cl. F24H 8/00; F28D 1/03; F27D 17/00; F28D 1/02; F24H 3/08; F24H 3/12

(52) U.S. Cl. CPC F24H 8/00; F24H 3/087; F24H 3/12; F27D 17/004; F28D 1/024; F28D 1/0375

(57) ABSTRACT

A secondary heat exchanger for use in a condensing gas-fired HVAC appliance including at least one conduit, including a non-circular transverse cross-sectional geometry. In one instance, the at least one conduit penetrates and is in contact with at least one plate fin. In another instance a fin is affixed to the at least one conduit.

### CROSS REFERENCE TO RELATED APPLICATIONS

The present application is related to, and claims the priority benefit of, U.S. Provisional Patent Application Ser. No. 61/929,653 filed Jan. 21, 2014, the contents of which are hereby incorporated in their entirety into the present disclosure.

### TECHNICAL FIELD OF THE DISCLOSED EMBODIMENTS

The presently disclosed embodiments generally relate to appliances for heating and cooling air, and more particularly, to a heat exchanger for use in a condensing gas-fired heating, ventilation and air-conditioning (HVAC) appliance.

### BACKGROUND OF THE DISCLOSED EMBODIMENTS

A typical condensing gas-fired HVAC appliance includes a flame or burner for heating flue gases, a primary heat exchanger for transferring heat from the heated gases to the circulated air, a secondary or condensing heat exchanger for transferring heat from the discharged gas of the primary heat exchanger to the circulated air, and a blower for circulating air through an interior space (or any surrounding area).

In some instances, the secondary or condensing heat exchangers are plate-type heat exchangers made from two opposing halves or half shells. Heat is transferred from the inside, between the half shells, to the exterior of the heat exchanger. In other instances, the secondary or condensing heat exchangers are tube and fin type heat exchangers made from a number of circular tubes penetrating a number of plate fins and having good thermal contact with the fins. Heat is transferred from inside each of the circular tubes to the plate fins, thereby releasing the latent heat of vaporization of the water in the flue gas and transferring this latent heat, along with sensible heat, to the air disposed outside the heat exchanger. However, such heat exchangers require a large number of tubes penetrating the plate fins to achieve an effective heat exchange process, and thus provide a given heat exchange efficiency. Therefore, there is a need for a secondary or condensing heat exchanger that improves the heat exchange efficiency with less number of tubes.

### SUMMARY OF THE DISCLOSED EMBODIMENTS

In one aspect, a secondary heat exchanger for use in a condensing gas-fired HVAC appliance is provided. In one embodiment, the heat exchanger includes at least one plate fin, each including a plate fin surface, and at least one plate fin aperture through the plate fin surface. The heat exchanger also includes at least one conduit, including an outer conduit surface, and a non-circular transverse geometry that penetrates the at least one plate fin aperture. In at least one embodiment, the outer conduit surface is in contact with the plate fin surface. In at least one embodiment, the heat exchanger includes at least two plate fins, each plate fin placed adjacent to one another to form a plate fin spacing. In one embodiment, the plate fin spacing is less than or equal to approximately 16 plate fins per inch.

In at least one embodiment, the non-circular transverse cross-sectional geometry includes an oval. In at least one embodiment, the oval includes a substantially elliptical geometry including a major axis length and a minor axis length. In at least one embodiment, the major axis length may be approximately 1.5 times the minor axis length.

In at least one embodiment, the non-circular transverse cross-sectional geometry includes a pair of opposing side walls, each having a proximal end, and a distal end. The at least one conduit further includes a first curved wall extending between each of the opposing side wall proximal ends, and a second curved wall extending between each of the opposing side wall distal ends.

In at least one embodiment, the secondary heat exchanger includes at least one conduit including a conduit outer surface, a longitudinal conduit length, a conduit width, and a non-circular transverse cross-sectional geometry. The secondary heat exchanger further includes at least one fin affixed to the conduit outer surface.

In at least one embodiment, the non-circular transverse cross-sectional geometry of the at least one conduit includes a pair of opposing side walls, each having a proximal end, a distal end, and an opposing side wall length. The at least one conduit further includes a first curved wall extending between each of the opposing side wall proximal ends, and a second curved wall extending between each of the opposing side wall distal ends. In at least one embodiment, a tube aspect ratio is defined by the opposing side wall length divided by the conduit width, and wherein the tube aspect ratio is less than or equal to 35. In at least one embodiment, at least two conduits are placed adjacent to one another to form a conduit spacing. In at least one embodiment, a tube spacing ratio is defined by the opposing side wall length divided by the conduit spacing, and wherein the tube spacing ratio is less than or equal to approximately 18. In at least one embodiment, the opposing side wall length may be less than or equal to approximately 7 inches. In at least one embodiment, conduit width may be less than or equal to approximately 1 inch. In at least one embodiment, the conduit spacing is less than or equal to approximately 3 inches.

In at least one embodiment, the at least one fin may be affixed to at least one of the opposing side walls along the longitudinal conduit length. In at least one embodiment, the at least one fin may be substantially rectangular in shape and arranged in a geometric pattern with the at least one opposing side walls. In at least one embodiment, the geometric patter is selected from a group consisting of: triangular, rectangular, and trapezoidal.

In one aspect, a condensing gas-fired HVAC appliance is provided. The condensing gas-fired HVAC appliance includes at least one primary heat exchanger and at least one secondary heat (condensing) exchanger disposed in a casing. In at least one embodiment, the condensing gas-fired HVAC appliance further includes a fan, an inducer assembly, and a burner assembly operably coupled to one another, and disposed in the casing.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1A is a perspective view of a heat exchanger according to at least one embodiment of the present disclosure;

FIG. 1B is a perspective view of a conduit used in a heat exchanger according to at least one embodiment of the present disclosure;

FIG. 2 is a perspective view of a heat exchanger according to at least one embodiment of the present disclosure;

FIG. 3 is a perspective view of a heat exchanger according to at least one embodiment of the present disclosure;

FIG. 4 is a perspective view of a condensing gas-fired HVAC appliance according to at least one embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

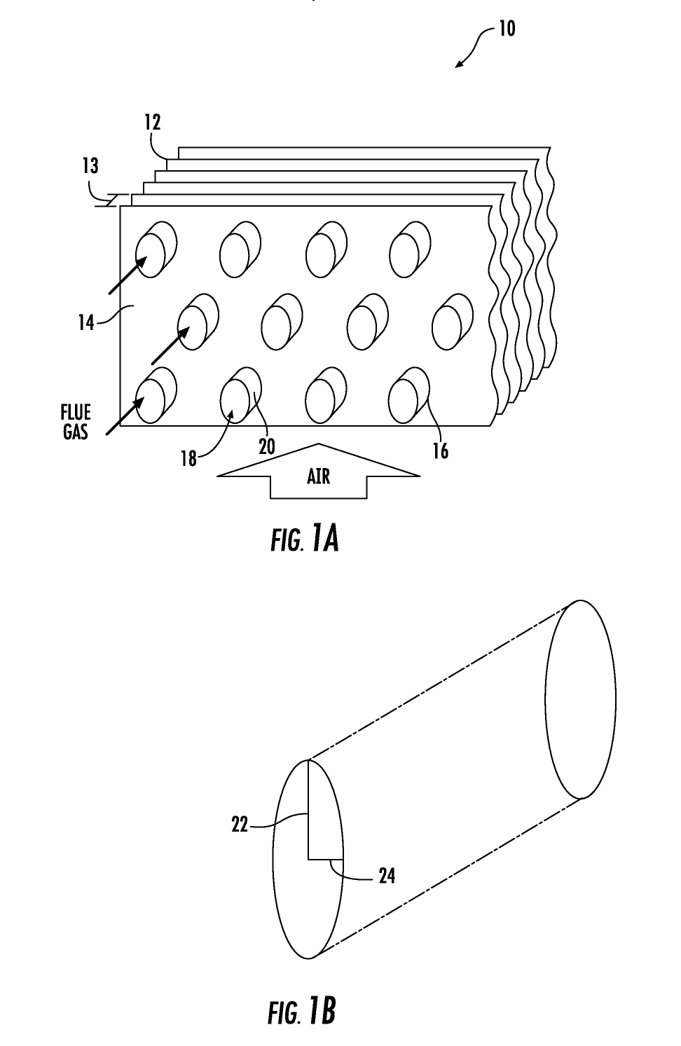

FIG. 1 illustrates a secondary heat exchanger for use in a condensing gas-fired HVAC appliance generally referenced at 10. The heat exchanger 10 includes at least one plate fin 12, each plate fin 12 including a plate fin surface 14 and at least one plate fin aperture 16 through the plate fin surface 14. It will be appreciated that the thickness of each of the at least one plate fins 12 may vary due to the required heat transfer from each of the at least one plate fins 12 to an airflow stream passing through the at least one plate fin 12 and minimize a pressure drop of the airflow stream through the at least one plate fin 12. The heat exchanger 10 also includes at least one conduit 18 penetrating each of the at least one plate fin apertures 16. The at least one conduit 18 includes an outer conduit surface 20 and a non-circular transverse cross-sectional geometry. In at least one embodiment, the outer conduit surface 20 is in contact with the plate fin surface 14 to promote the transfer of heat between the at least one conduit 18 and the at least one plate fin 12. In one embodiment, the heat exchanger 12 includes at least two plate fins 12, each plate fin 12 placed adjacent to one another to form a plate fin spacing 13. In one embodiment, the plate fin spacing 13 is less than or equal to approximately 16 plate fins 12 per inch. It will be appreciated that the plate fin spacing 13 is greater than 16 plate fins 12 per inch. It will be appreciated that the at least one plate fin 12 and the at least one conduit 18 may be composed of any durable material, for example copper alloy, aluminum alloy, and stainless steel to name a few non-limiting examples, that promote the transfer of gas-fired heat. It will also be appreciated that each of the at least one plate fins 12 includes a density sufficient to transfer heat from the fins to the air flow stream passing through the fins and to minimize the pressure drop of the air flow stream through the at least one fin 12. The term ‘density’ here refers to the number of plate fins 12 arranged along the longitudinal length of the conduit 18 and the associated plate fin spacing 13.

In at least one embodiment, as shown in FIG. 1B, the non-circular transverse cross-sectional geometry of the at least one conduit 18 includes an oval geometry. As used herein, the term “oval” is intended to encompass a smooth, simple (not self-intersecting), convex, closed, plane curve including two unequal axes of symmetry where no three points on the curve are collinear. An ellipse meets the definition of oval as used herein, but not all ovals as defined herein are ellipses. In at least one embodiment, the oval includes a substantially elliptical geometry including a major axis length 22 and a minor axis length 24. In at least one embodiment, the major axis length 22 may be approximately 1.5 times the minor axis length 24. It will be appreciated that the major axis length 22 may be greater than or less than approximately 1.5 times the minor axis length 24. It will be appreciated that the oval geometry increases the internal surface area of the at least one conduit 18 as compared to a conduit having the same cross-sectional area and a circular geometry; thus, enhancing the heat transfer between the at least one conduit 18 and the at least one plate fin 12.

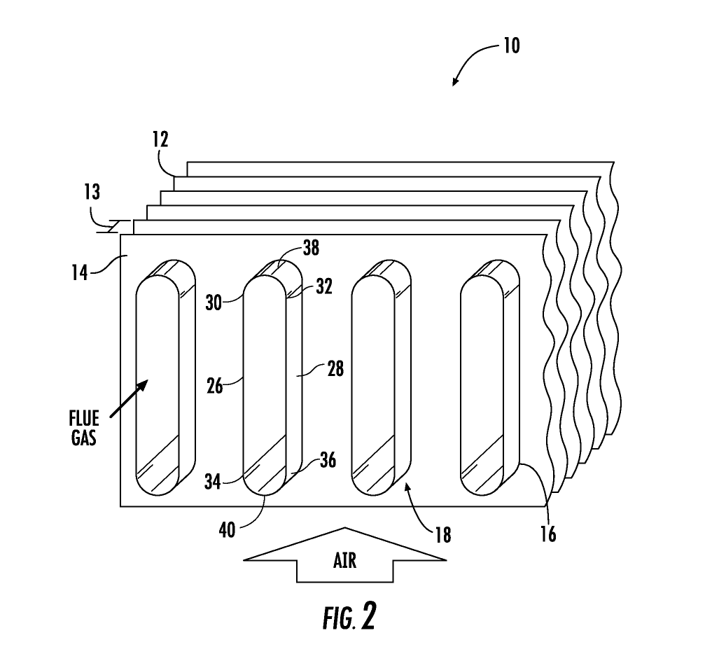

In at least one embodiment, as shown in FIG. 2, the non-circular transverse cross-sectional geometry of the at least one conduit 18 includes a pair of opposing side walls 26 and 28, each having a respective proximal end 30 and 32, and a respective distal end 34 and 36. The at least one conduit 18 further includes a first curved wall 38 extending between each of the opposing side wall proximal ends 30 and 32, and a second curved wall 40 extending between each of the opposing side wall distal ends 34 and 36. It will be appreciated that the non-circular transverse cross-sectional geometry of the at least one conduit 18 increases the internal surface area therein as compared to a conduit having the same cross-sectional area and a circular geometry; thus, enhancing the heat transfer between the at least one conduit 18 and the at least one plate fin 12. It will also be appreciated that the non-circular transverse cross-sectional geometry may decrease the air-side pressure drop of a gas-fired condensing HVAC appliance, later described herein, by streamlining the tube form factor with respect to the direction of airflow, and additionally by reducing the number of plate fins 12 required for efficient heat transfer. As a result, power consumption of a fan may be reduced, and efficiency of the condensing gas-fired HVAC appliance may be increased. It will be appreciated that each of the at least one plate fins 12 includes a density sufficient to transfer heat from the fins to the air flow stream passing through the fins and to minimize the pressure drop of the air flow stream through the at least one fin 12.

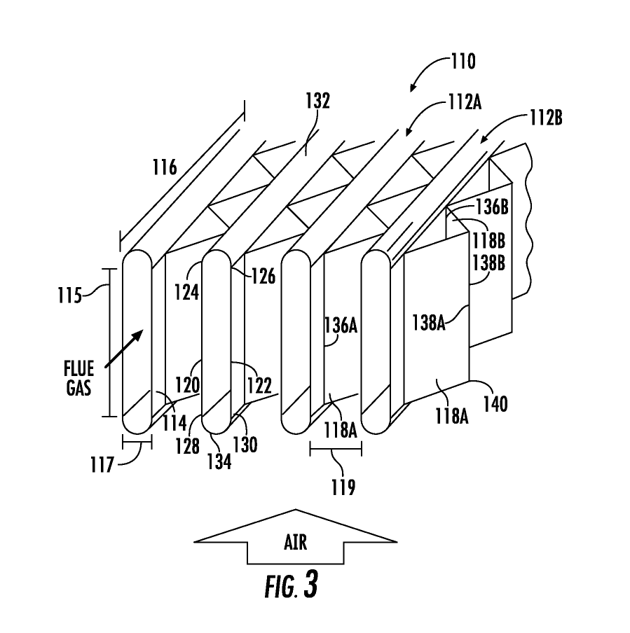

In at least one embodiment, as shown in FIG. 3, a heat exchanger 110 includes at least one conduit 112 including a conduit outer surface 114, a longitudinal conduit length 116, a conduit width 117, and a non-circular transverse cross-sectional geometry. The heat exchanger 110 further includes at least one fin 118 affixed to the conduit outer surface 114. In at least one embodiment, the at least one fin 118 may be affixed to the at least one conduit 112 to promote the transfer of heat between the at least one conduit 112 and the at least one fin 118. It will be appreciated that the at least one fin 118 and the at least one conduit 112 may be composed of any durable material, for example copper alloy, aluminum alloy, and stainless steel to name a few non-limiting examples, that promote the transfer of gas-fired heat. In at least one embodiment, the non-circular transverse cross-sectional geometry of the at least one conduit 112 includes a pair of opposing side walls 120 and 122, each having a respective proximal end 124 and 126, a respective distal end 128 and 130, an opposing side wall length 115. The non-circular transverse cross-sectional geometry of the at least one conduit 112 further includes a first curved wall 132 extending between each of the opposing side wall proximal ends 124 and 126, and a second curved wall 134 extending between each of the opposing side wall distal ends 128 and 130.

In at least one embodiment, a tube aspect ratio is defined by the opposing side wall length 115 divided by the conduit width 117, and wherein the tube aspect ratio is less than or equal to 35. In at least one embodiment, at least two conduits 112A and 112B are placed adjacent to one another to form a conduit spacing 119. In at least one embodiment, a tube spacing ratio is defined by the opposing side wall length 115 divided by the conduit spacing 119. The conduit spacing 119 governs the volume of space available for the at least one fins 118; thus, impacting both the heat transfer and the air-side pressure drop. In at least one embodiment, the opposing side wall length 115 may be less than or equal to approximately 7 inches. It will also be appreciated that the opposing side wall longitudinal length 115 may be greater than 7 inches. In at least one embodiment, conduit width 117 may be less than or equal to approximately 1 inch. It will also be appreciated that the conduit width 117 may be greater than approximately 1 inch. In at least one embodiment, the conduit spacing 119 is less than or equal to approximately 3 inches. It will also be appreciated that the conduit spacing is greater than approximately 3 inches.

While the example in FIG. 3 shows the opposing side walls 120 and 122 having equal opposing side wall longitudinal lengths 115, it will be appreciated that the opposing side walls 120 and 122 may have different opposing side wall longitudinal lengths 115.

In at least one embodiment, the at least one fin 118 may be affixed to at least one of the opposing side walls 120 and 122 along the longitudinal conduit length 116. In at least one embodiment, the at least one fin 118 may be substantially rectangular in shape and arranged in a geometric pattern with the at least one opposing side walls 120 and 122. In at least one embodiment, the geometric pattern is selected from a group consisting of: triangular, rectangular, and trapezoidal. For example, a first fin 118A may have a side 136A affixed to the opposing side wall 122 (or 120) of a conduit 112A. The opposite, congruent side 138A of the first fin 118A may be affixed to a side 138B of a second fin 118B to form an apex 140 above the opposing side wall 122 (or 120). In some embodiments, the apex 140 may be affixed to an opposing side wall 120 (or 122) of another conduit 112B. The opposite, congruent side 136B of the second fin 118B may be affixed to the opposing side wall 122 (or 120) of the conduit 112A. It will be appreciated that the non-circular transverse cross-sectional geometry increases the internal surface area of the at least one conduit 112 as compared to a conduit having the same cross-sectional area and a circular geometry; thus, enhancing the heat transfer between the at least one conduit 112 and the at least one fin 118. It will be appreciated that the thickness of each of the at least fins 118 may vary due to the required heat transfer from each of the at least one fins 118 to an airflow stream passing through the at least one fins 118 and a pressure drop of the airflow stream through the at least one fins 118.

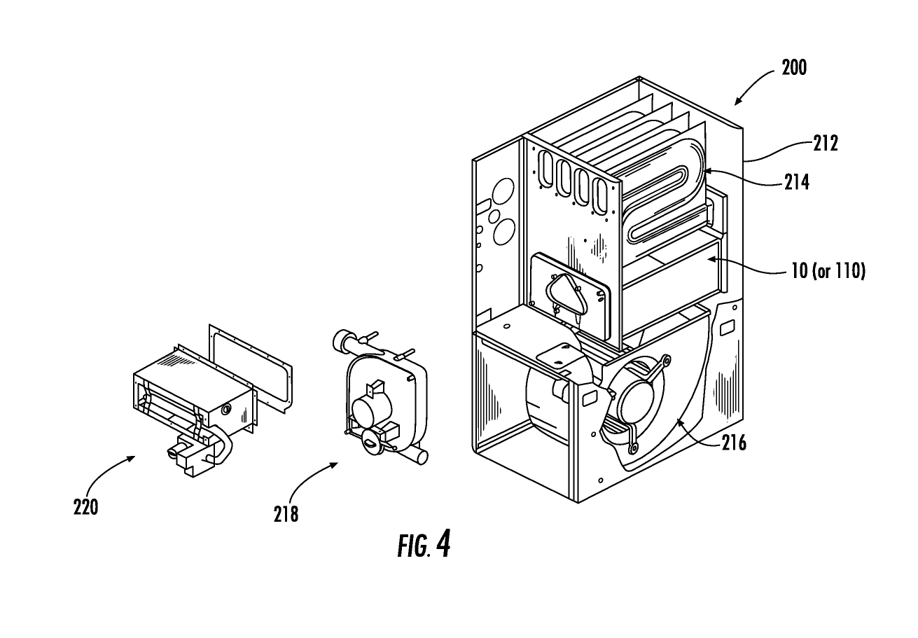

According to at least one embodiment, FIG. 4 illustrates a condensing gas-fired HVAC appliance generally referenced at 200. It will be appreciated that the condensing gas-fired HVAC appliance 200 may be a furnace or a packaged heating and cooling product to name at least two non-limiting examples. The condensing gas-fired HVAC appliance 200 may be configured to provide heated air to an interior space. The condensing gas-fired HVAC appliance 200 includes a primary heat exchanger 214 and a secondary heat exchanger 10 disposed in a casing 212. It will be appreciated that the at least one secondary heat exchanger 10 may be configured as the heat exchanger 110, previously described herein. In at least one embodiment, the condensing gas-fired HVAC appliance 200 further includes an air-circulating fan 216, an inducer fan assembly 218, and a burner assembly 220 disposed in the casing 212. For example, during typical operation of a condensing gas-fired furnace, the inducer fan assembly 218 operates to provide a sufficient draft through the primary heat exchanger 214. Once a sufficient draft is present, the burner assembly 220 operates to ignite a gas with the draft. The ignited gas produces combustion gases that travel through the primary heat exchanger 214 where the majority of the heat is removed as air circulated from the fan 216 passes over the primary heat exchanger 214 and secondary heat exchanger 10 (or 110). The exhausted combustion gases exits the primary heat exchanger 214 where they enters the secondary heat exchanger 10 (or 110) through the at least one conduit 18 (or 112). Here, more heat is extracted from the exhausted combustion gases and as a result the gases are cooled to the point that the water vapor contained therein begins to condense into a liquid water. After passing through the secondary heat exchanger 10 (or 110), the combustion gases, less the condensed water, exit the condensing gas-fired HVAC appliance 200 through a flue conduit (not shown).

It will be appreciated that the at least one conduit 18 and 112 include a non-circular transverse cross-sectional geometry to increase the internal surface area therein as compared to a conduit having the same cross-sectional area and a circular geometry; thus, providing an increased area for heat transfer and increasing the steady-state efficiency of the condensing gas-fired HVAC appliance 200.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A heat exchanger for use in a condensing gas-fired HVAC appliance comprising:
at least one plate fin, each including a plate fin surface and at least one of plate fin aperture through the plate fin surface; and
at least one conduit including an outer conduit surface and a conduit longitudinal length;
wherein the at least one conduit penetrates the at least one plate fin aperture;
wherein the at least one conduit includes a non-circular transverse cross-sectional geometry.

2. The heat exchanger of claim 1, wherein the outer conduit surface is in contact with the plate fin surface.

3. The heat exchanger of claim 1 comprising: at least two plate fins, each plate fin placed adjacent to one another to form a plate fin spacing.

4. The heat exchanger of claim 3, wherein the plate fin spacing is less than or equal to approximately 16 plate fins per inch.

5. The heat exchanger of claim 1, wherein the non-circular transverse cross-sectional geometry comprises an oval.

6. The heat exchanger of claim 5, wherein the oval comprises a substantially elliptical geometry including a major axis length and a minor axis length.

7. The heat exchanger of claim 6, wherein the major axis length is approximately 1.5 times the minor axis length.

8. The heat exchanger of claim 1, wherein the non-circular transverse cross-sectional geometry comprises:
a pair of opposing side walls, each opposing side wall including a proximal end, a distal end;
a first curved wall extending between each of the opposing side wall proximal ends; and
a second curved wall extending between each of the opposing side wall distal ends.

9. A heat exchanger for use in a condensing gas-fired HVAC appliance comprising:
at least one conduit including an outer conduit surface, a longitudinal conduit length, and a conduit width; and
at least one fin affixed to the outer conduit surface;
wherein the at least one conduit includes a non-circular geometry.

10. The heat exchanger of claim 9, wherein the at least one fin is affixed along the longitudinal conduit length.

11. The heat exchanger of claim 9, wherein the non-circular geometry comprises:
a pair of opposing side walls, each including a proximal end, a distal end, and an opposing side wall length;
a first curved wall extending between each of the opposing side wall proximal ends; and
a second curved wall extending between each of the opposing side wall distal ends.

12. The heat exchanger of claim 11, wherein a tube aspect ratio is defined by the opposing side wall length divided by the conduit width, and wherein the tube aspect ratio is less than or equal to approximately 35.

13. The heat exchanger of claim 11 comprising: at least two conduits, each conduit placed adjacent to one another to form a conduit spacing.

14. The heat exchanger of claim 13, wherein a tube spacing ratio is defined by the opposing side wall length divided by the conduit spacing, and wherein the tube spacing ratio is less than or equal to approximately 18.

15. The heat exchanger of claim 14, wherein the opposing side wall length is less than or equal to approximately 7 inches.

16. The heat exchanger of claim 14, wherein the conduit width is less than or equal to approximately 1 inch.

17. The heat exchanger of claim 14, wherein the conduit spacing is less than or equal to approximately 3 inches.

18. The heat exchanger of claim 10, wherein the at least one fin is configured in a substantially rectangular shape and arranged in a geometric pattern.

19. The heat exchanger of claim 18, wherein the geometric pattern is selected from the group consisting of: triangular, rectangular, and trapezoidal.

20. A condensing gas-fired HVAC appliance comprising:
a casing;
a primary heat exchanger disposed in the casing; and
a secondary heat exchanger, operably coupled to the at least one primary heat exchanger, and disposed in the casing;
wherein the secondary heat exchanger comprises:
at least one conduit including an outer conduit surface, a longitudinal conduit length, and a conduit width;
wherein the at least one conduit includes a non-circular transverse cross-sectional geometry.

21. The condensing gas-fired HVAC appliance of claim 20 wherein the secondary heat exchanger further comprises:
at least one plate fin, each including a plate fin surface and at least one plate fin aperture through the plate fin surface;
wherein the at least one conduit penetrates the at least one plate fin aperture.

22. The condensing gas-fired HVAC appliance of claim 21, wherein the outer conduit surface is in contact with the plate fin surface.

23. The condensing gas-fired HVAC appliance of claim 21 comprising: at least two plate fins, each plate fin placed adjacent to one another to form a plate fin spacing.

24. The condensing gas-fired HVAC appliance of claim 23, wherein the plate fin spacing is less than or equal to approximately 16 plate fins per inch.

25. The condensing gas-fired HVAC appliance of claim 21, wherein the non-circular transverse cross-sectional geometry comprises an oval.

26. The condensing gas-fired HVAC appliance of claim 25, wherein the oval comprises a substantially elliptical geometry including a major axis length and a minor axis length.

27. The condensing gas-fired HVAC appliance of claim 26, wherein the major axis length is approximately 1.5 times the minor axis length.

28. The condensing gas-fired HVAC appliance of claim 21, wherein the non-circular transverse cross-sectional geometry comprises:
a pair of opposing side walls, each opposing side wall including a proximal end, a distal end;
a first curved wall extending between each of the opposing side wall proximal ends; and
a second curved wall extending between each of the opposing side wall distal ends.

29. The condensing gas-fired HVAC appliance of claim 20 wherein the secondary heat exchanger further comprises: at least one fin affixed to the outer conduit surface.

30. The condensing gas-fired HVAC appliance of claim 29, wherein the at least one fin is affixed along the longitudinal conduit length.

31. The condensing gas-fired HVAC appliance of claim 29, wherein the non-circular geometry comprises:
a pair of opposing side walls, each including a proximal end, a distal end, and an opposing side wall length;
a first curved wall extending between each of the opposing side wall proximal ends; and
a second curved wall extending between each of the opposing side wall distal ends.

32. The condensing gas-fired HVAC appliance of claim 31, wherein a tube aspect ratio is defined by the opposing side wall length divided by the conduit width, and wherein the tube aspect ratio is less than or equal to approximately 35.

33. The condensing gas-fired HVAC appliance of claim 31 comprising: at least two conduits, each conduit placed adjacent to one another to form a conduit spacing.

34. The condensing gas-fired HVAC appliance of claim 33, wherein a tube spacing ratio is defined by the opposing side wall length divided by the conduit spacing, and wherein the tube spacing ratio is less than or equal to approximately 18.

35. The condensing gas-fired HVAC appliance of claim 34, wherein the opposing side wall length is less than or equal to approximately 7 inches.

36. The condensing gas-fired HVAC appliance of claim 34, wherein the conduit width is less than or equal to approximately 1 inch.

37. The condensing gas-fired HVAC appliance of claim 34, wherein the conduit spacing is less than or equal to approximately 3 inches.

38. The condensing gas-fired HVAC appliance of claim 30, wherein the at least one fin is configured in a substantially rectangular shape and arranged in a geometric pattern.

39. The condensing gas-fired HVAC appliance of claim 38, wherein the geometric pattern is selected from the group consisting of: triangular, rectangular, and trapezoidal.

40. The condensing gas-fired HVAC appliance of claim 20, further comprising:
a fan, a burner assembly, and an inducer assembly disposed in the casing;
wherein the burner assembly, and the inducer assembly are operably coupled to the primary heat exchanger.
